(19) United States
(12) Patent Application Publication
(10) Pub. No.: US 2003/0051242 A1
(43) Pub. Date: Mar. 13, 2003

(54) Method of advertising utilizing a catalog program with locator index bar

(76) Inventor: William F. Donnelly, Edina, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/228,691

(22) Filed: Aug. 27, 2002

Related U.S. Application Data
(60) Provisional application No. 60/316,641, filed on Aug. 31, 2001.

(51) Int. Cl. G06F 3/00

(52) U.S. Cl. 725/42

(57) ABSTRACT

In general, the method of advertising utilizes a program which brings information generally found in newspaper or other types of weekly advertising supplements to a persons home via the television or pre-recorded media such as videotape and compact discs, and other broadband or satellite delivery systems. The method of advertising utilizes digital electronic procedures and components to create, store, edit, and organize, a variety of photographic or design images. When an advertisement is fully assembled a catalog index bar which represents the sequence in which the retailer(s) and their product images or merchandise categories will appear is created and placed to appear over a portion of the images visible on the screen. This locator index bar dynamically functions to apprise viewers of their present viewing position in the context of the total program.

### BACKGROUND OF THE INVENTION

Marketers have traditionally used printed materials to present detailed communications. Printed matter is especially prevalent in communication with several items or components. Newspapers frequently distribute multi-page advertising supplement inserts (sometimes known as circulars) which detail prices and features of several items. These printed materials may be hard to create and are difficult to keep up-to-date: changes in product features or price changes require additional time and expense to revise artwork and reprint any advertising materials.

Beyond costly inefficiencies associated with production of print materials, the unwillingness or the inability of audiences to fully comprehend written information limits the effectiveness of printed material.

Broadly available educational opportunities for individuals have not resulted in an expanded commitment to reading. Many people cannot read, and an increasing number of individuals have chosen not to commit themselves to the task or habit of reading. Daily newspapers that historically achieved readership among 70% of adults now reach less than half the population each day. At the same time, magazine circulation levels have also dropped dramatically. Large circulation, mass audience magazines such as Life, Look and The Saturday Evening Post have gone out of business, and have been replaced by small, tightly focused publications that appeal to increasingly elite audiences. Print-based advertising currently misses major portions of the population, including disproportionately large numbers of individuals that could benefit from the type of information generally contained in price-oriented advertising circulars. While Sunday newspapers only reach 55% of homes, the weekly television penetration exceeds 90% and Internet usage already approaches 50%.

Visual presentation is broadly recognized as a superior form of communication but is limited by its ability to continuously capture and sustain attention. Showing different images and having motion within the images are techniques commonly used to increase understanding and maintain interest in the presentation. But even these techniques often cannot sustain interest over a long presentation. An interesting and involving creative presentation may expand attention. Studies indicate that viewers generally respond better to situations that give them control over the presentation.

### GENERAL DESCRIPTION OF THE INVENTION

The present invention relates to a system for creating, assembling and distributing video materials which may function as an advertising catalog or circular which is distributed using broadcast or broadband telecommunication channels or vehicles. A standardized protocol for assembling each individual advertiser's images allows for inclusion of an advertising package in a larger compilation of packages representative of products/services which is, in turn, assembled on a visual template which may or may not include thematic messages. The standardized system is invoked so that messages of multiple advertisers may be joined to form program format length units (typically 30-, 60-, 90-minutes) which are commonly available for purchase from cable and broadcast television outlets. Each advertiser's product or service offerings will be broadly grouped and classified within their advertising segments, e.g. dry foods, bakery, meats, household cleaners, or paper products in the case of supermarket advertisers; and men's fashions, women's fashions, or children's clothing, etc., in the case of department store advertisers. Each segment's classification will be included on a label that is displayed using an on-screen Locator Index Bar. This display will track the progressive order of presentation of produced classifications or items within each advertiser's own segment via a dynamic index bar. The index bar indicates the classification of product/service grouping of items currently being viewed, and the index bar further illustrates which classes or items have already been shown, and those items which will be shown in the future. On programs having multiple advertisers, this on-screen “index bar” may also indicate which enterprises' advertisements have already appeared, and those firms whose ads are still to come. Concurrently, software will track the presentation length of each segment and the cumulative length of the combined segments as each is assembled. The information obtained will specify the length of additional editorial or advertising matter needed to fulfill to overall program time allotment.

The present invention solves the above-identified problem related to the absence of sustained attention of viewers by giving advertisers an inexpensive method to create effective and timely video presentations incorporating any desired elements available for observation in print circulars. The system for advertising creates a visual program for standard television, for rebroadcast on VCR or PVR devices, on the Internet and with emerging interactive television formats. Digital image technology provides the foundation for the creation of a variety of artistic video applications from a single image. Using independent digital images allows for efficient storage and reuse of the images during advertising. Affixing these images onto a standardized template permits the use of the images across a variety of visual contexts/formats as well as allowing advertisers the flexibility to frequently update price and feature information for the applicable images. The locator index bar as displayed on the screen throughout the program empowers viewers to direct their attention, or to scroll through a video advertising program to view portions of the overall presentation which may interest the individual most.

Using digital and/or other photographic equipment, an operator or coordinator may collect and store multiple perspectives of an advertiser's product or group of products. Alternatively, existing photograph equipment may be used to record an advertiser's product or group of products. The recording of information such as the camera position will be harder to retrieve and/or record when using existing photographic equipment. Therefore, the use of existing photographic equipment is optional as opposed to an intrinsic part of the editing. The camera position record may be effective as images are enlarged through a zoom feature or a pan feature which may be readily available within a digital image. Also, tracing of the camera position may further be facilitated through the use of digital images.

A storage device receives and codes product and camera position data pertinent to each image. These codes are used in editing which may combine the images of several products to create a longer form piece of visual communication. The resulting product database is kept current when prerecorded images are retrieved and the individual elements altered or replaced to reflect any changes.

Materials may be customized, updated and corrected to reflect the latest information for inclusion in the advertising program. As the presentation is assembled, a Visual Locator Index Bar, which represents each of the major portions and visual classification of the advertisement, is created. Arranged either vertically or horizontally on the screen, this visual locator bar may be superimposed over a portion of the primary visual portion and used to indicate what portion of the overall presentation is currently being shown. This directory-like index bar feature helps to sustain or focus viewer attention by showing viewers an overview of the presentations elements available for review and indicating the relative position in the presentation of the images currently being observed. Viewers may adjust their activities or attention to correspond with those parts of the program which interest them and disregard portions of the program for which little interest exists. When used in conjunction with recording devices or other interactive media, the index bar may be used to fast-forward, or scroll toward, or click-upon a preferred location.

The invention allows timely, cost effective and high quality presentation of otherwise complex communications using video presentation. Beyond video catalogs and circulars, it has potential value in several communication applications, including training films and instruction videos. It allows users to update and to customize materials. The invention also organizes advertising materials in such a manner as to generate interest and involvement by observers. Presentations developed using this invention may offer new and better information to all individuals, especially those unwilling or unable to learn through printed materials.

### BRIEF DESCRIPTION OF THE SEVERAL VIEWS OF THE DRAWING(S)

FIG. 1 shows an image and index bar for a program.

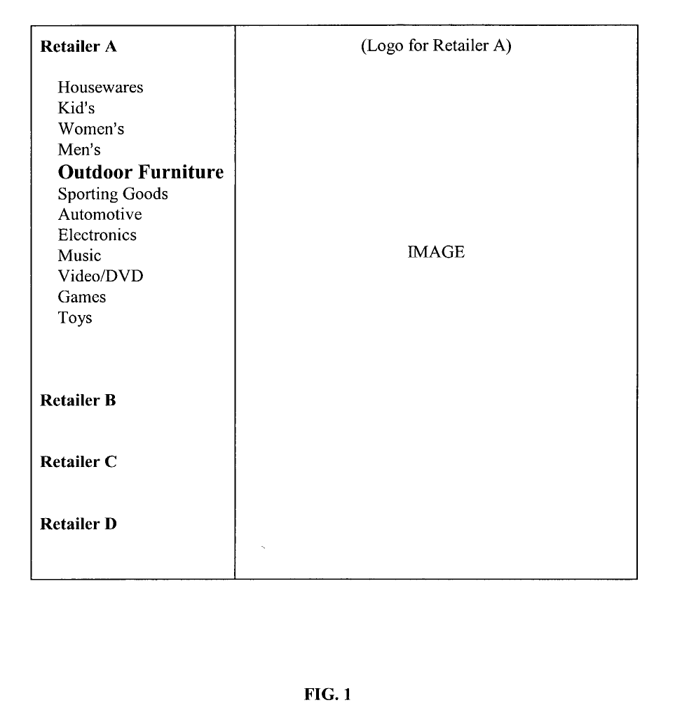

FIG. 2 shows an alternative image and index bar for a program.

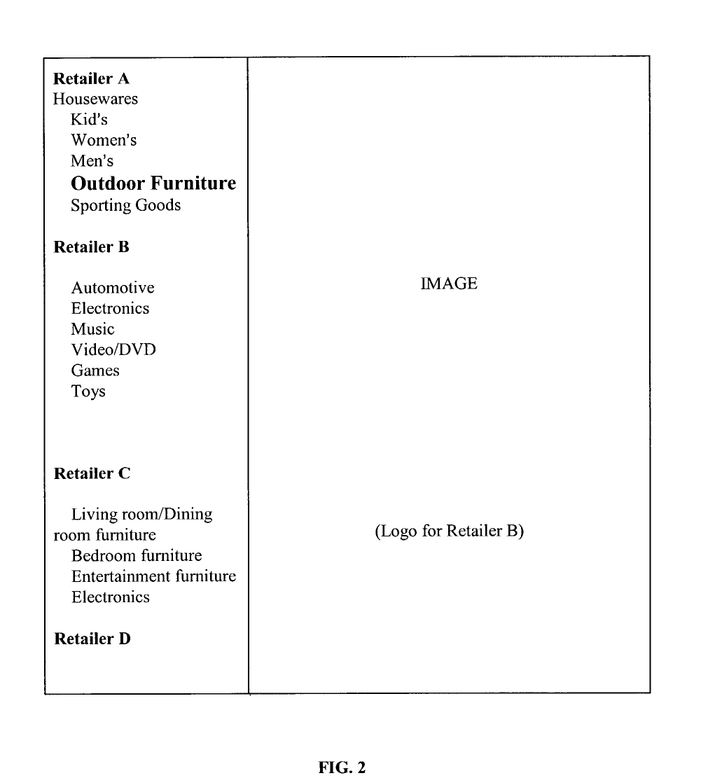

FIG. 3 shows an alternative image and index bar for a program.

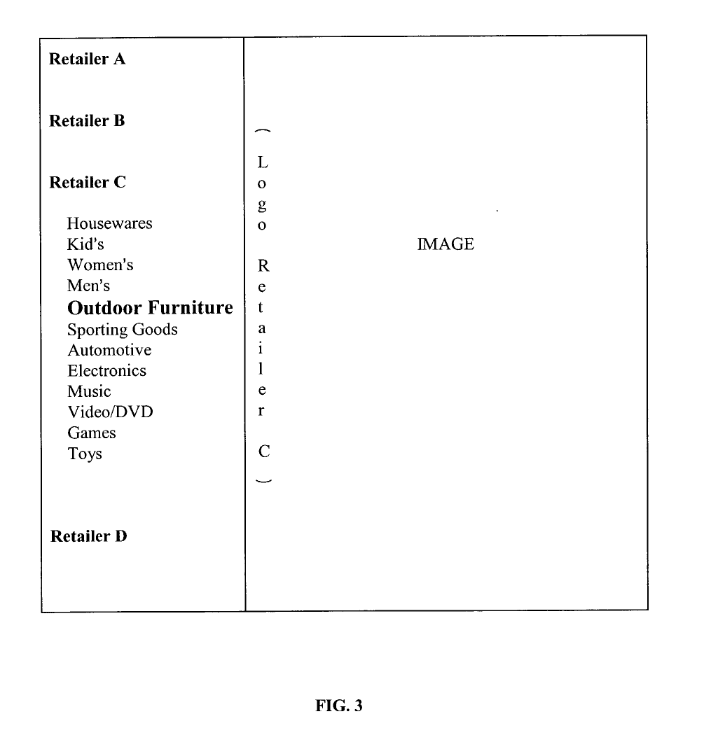

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

The method for utilizing a catalog advertising program with a locator index bar generally initiates upon an individual securing program space as provided by a television or cable network or other video provider. Once available program space has been secured, a commitment to a daily, weekly, bi-weekly, or once a month advertisement may be arranged. An individual may desire to schedule the method for advertising described herein during a particular repeatable time slot for recognition by viewers.

An advertiser may then organize any desired product or service information or material to be advertised into topics, products, and/or prices for observation by individuals. The advertiser typically will record images either photographically or through a digital recording device as related to the organized topics, products, and/or prices as previously identified.

Next, processing and editing of the recorded images will occur for identification of images to be transmitted for observation by individuals. An advertiser will repeat the methodology for identification of other topics, products, prices, and the recording of images with respect to any number of advertisers/retailers.

Once final images have been determined, a coordinator may then organize the content from each advertiser into an advertiser/retailer specific ordered presentation. The coordinator will then combine one or more advertising specific order presentations into a composite advertising presentation for viewing within a time slot as acquired from the television or cable network provider.

Next, either the coordinator or the advertiser will create an index for identification of the relative location of the recorded finalized images within the composite presentation. The coordinator or the advertiser will then attach the index to the composite presentation for the provision of a combined advertisement. The coordinator will then arrange for the transmission of the combined advertisement within the time slot as contracted from the television and cable networks, for viewing by individuals.

It is anticipated that an individual may record the combined advertisement and composite presentation on a personal video recording device, VCR, PDA, personal computer, and/or personal computer successor equipment.

The location of the index bar within the screen display may be varied at the preference of a retailer. The index bar may be positioned vertically along either the left side or right side of the screen or horizontally along the top and/or bottom of the screen, or even polka doted within different portions of the interior of the screen. The location of the index bar and/or index bar information may be selected based upon an individual retailer's requirements. An individual may then, upon completion of the recording of the advertisement, exercise fast forward and/or reverse functions of the recording device display unit to scroll or proceed to an area of the composite presentation of interest to the individual. The index bar enables an individual to quickly scroll to an area of interest for observation of products and/or images as available from an advertiser/retailer.

Alternatively, the advertiser/retailer may organize recorded images into files and/or subfiles for observation via the global communication network or internet. In this embodiment, an advertiser will organize the product or service content into an advertiser specific order presentation. The coordinator may combine one or more advertising specific ordered presentations into a composite file. Next, links will be required to be created in order to provide a pathway or direction to the composite file. An index bar will be created for the recorded images for identification of files and/or subfiles within the composite file. The links to the files/subfiles and/or advertiser/retailer will be verified within the composite file.

The advertiser will next open a website to enable a consumer to access the files/subfiles and/or advertiser specific information within the composite file for observation of previously recorded images. An individual may navigate the index to utilize links to specific desired files and/or subfiles or other advertiser specific information to retrieve prerecorded images and/or other information.

The composite files may contain information on a specific advertiser such as logos, trademarks, pricing, specials, retail locations, business hours and other information. It should be noted that the index bar and/or recorded images for observation over the television or cable networks may also include specific advertiser or retailer information such as logos, trademarks, pricing, specials, retail locations, and business hours.

In general, the method of advertising as illustrated and described herein enables advertisers/retailers to display information in a television, cable and/or internet media to supplement, and/or replace, printed circulars as contained within newspapers or other printed advertisements. It is anticipated that individuals will receive substantially similar information as viewed within the television and/or cable network transmissions as compared to the reading of a circular within a newspaper. It is believed that individuals will likely record television and/or cable programming for utilization of the index bar to quickly direct an individual to a desired area of interest for viewing of recorded images and pricing related to a particular product.

It is anticipated that the method of advertising as illustrated and described herein may be supplemental to the continued use of circulars within newspaper advertisements. The images recorded for inclusion within the circular to be distributed with a newspaper may be readily copied by existing technology onto tape and/or other recording means for display within the television, cable, and/or other media such as the internet, with minimal effort being expended for creation of the index bar. Enlarged viewer markets may therefore be established for a particular retailer's products. The organization of the specific embodiments described herein has been provided for illustrative purposes and may be significantly varied at the preference of an individual.

It is anticipated that one or more retailers will participate in the method of advertisement for a specific time slot of cable and/or television programming. Alternatively, a significant advertiser and/or retailer may desire an entire slot of 30-, 60-, and/or 90-minute programming for display of available products.

The method of advertising described herein enables an advertiser to create, capture, store, edit, organize, and catalog photographic or design images representative of advertising materials to replicate the functional role of advertising circulars within newspapers and/or direct mail. The method of advertising or distribution will generally be broadcast or displayed over commercial television, the worldwide telecommunications network or internet, broadband, cable, or satellite to broadly promote the sale of an advertisers products or the use of a providers services.

Digital or other images of products or service offerings may be easily collected and encoded with detailed information concerning the product and/or services featured for display or for retrieval for use within a future advertising program.

The individual encoded images may then be combined into a visual presentation package representative of products and/or services of a single or multiple providers.

The template and/or index bar is primarily used for identification of thematic materials and precise price and product information.

A finished composite advertising package from one advertiser may be easily combined with similar or different advertising packages from other advertisers to create program link segments for distribution over broadcast and/or broadband equipment.

The use of the index bar is not mandatory. The index bar is conceived to facilitate the convenience of use of the advertising program to enable and individual to scroll to a location of interest in a short duration of time.

The index bar has a dynamic function to apprise viewers of the present viewing position within the advertising program in relation to the advertising program as a whole, while simultaneously advising an individual of the previously displayed images and images representative of products and/or services yet to be displayed.

The method of advertising facilitates flexible presentation of images to communicate detailed information such as pricing, colors, dimensions, or other details. The method of advertising also facilitates last minute editing of the presentation and future use or reuse of stored visual images for inclusion of up-dated information.

The method for advertising herein may also be distributed to individuals through the provision of VCR tapes, discs, and/or compact discs, as provided within a circular, as mailed to a household, and/or as picked up by an individual at a retail location.

The method for advertising may initiate with the assembly of an advertising packet which may be formed or compiled by first identifying the specific products and/or services to be advertised. Images of the products and/or services may then be obtained through the use of a camera, digital camera, and/or video recording device. The recorded images may then be electronically and/or digitally stored within a storage device. If required, identified images may be scanned for digital storage. Further, scanned digital images may be edited to improve the quality which may be lost during the scanning process.

The stored digital images may then be retrieved and edited to provide a desired content and/or quality for an advertising packet. Individual edited images may then be assembled into a desired sequence for recording and/or storage on a tape or digitally within a storage device. The sequential organization and recording of images may be repeated until such time as a desired composite image package is obtained. Each composite image package may be representative of a desired amount of time for transmission over television, cable, and/or broadband networks.

Multiple composite image packages may be organized and assembled into an advertising program for display within a prearranged viewing slot having a broadcast link of a traditional period of time of 30, 60, and/or 90 minutes.

Following assembly of the advertising program, a coordinator may add an index or index bar to the program to advise viewers of the relative observation location of the viewed images as well as communicating which images have been previously displayed, or which images are scheduled to be displayed in the near future. The inclusion of an index/index bar may be manually or automatically inserted into the advertising program.

Next, the advertising program, including the index/index bar, may be stored on a tape or digitally within a recording device as a complete program ready for display to individuals. Therefore, the advertising program as stored may be transferred to distributors or networks for transmission within a prescheduled viewing slot.

During the indexing routine, additional editing, reorganization, deletion, inclusion, and/or voice information may be entered into the advertising package. In addition, a second index bar may be established for communication of information such as price, color, sizes, and/or specials on products and/or services as displayed within the advertising program.

An advertising coordinator has previously, or currently is, engaged in the scheduling of program time through the purchase of any desired length of viewing slot. The programmed viewing time may be obtained from television networks, cable networks, the global telecommunications network (internet), and/or satellite TV.

A tape or electronic recording of the program may then be delivered to a studio/control center prior to a broadcast which displays the tape or electronically stored program during the reserved viewing slot. Delayed and/or replayed viewing slots are also available for viewing of the program. An individual may also record or tape the program as a broadcast for viewing at a convenient time and/or location. Devices utilized to accomplish viewing by an individual may include but are not necessarily limited to the use of VCR's, TiVO, Ultimate TV, TV, the global telecommunications network, and computers as well as other types of broadcasting media.

An individual may conveniently review the composite program either during a scheduled time slot or off-air through the use of a replay feature associated with a recording device. The recording device may be a writable DVD, CD, VCR, and/or computer to name a few.

In addition, the composite program, prior to inclusion of an index bar, may be copied any number of times to enable the coordinator to select a language specific index/index bar for observation by a certain group or class of viewers. It is anticipated that a composite program may be viewed in English, Spanish, and/or any other desired language. In addition, target content for the composite program and index bar may include elements directed to appeal to demographic classifications such as teenagers, parents, men, women, grandparents, and/or a mix therebetween. Geographically located individuals, seasonal themes, and industrial product classifications which may include, but are not necessarily limited to, gardening, home repair, clothing, entertainment, and/or electronics may also be provided to name a few.

TABLE 1
MECHANICS

| | | |
|---|---|---|
| Assembly | | |
| Camera to Photograph | Video Taping | Digital Storage |
| | (digital or not) | |
| Indiv. Element Assembly | Editing (Avid | Multiple assembly |
| (tape/digital) | Technologies or Apple | |
| | Final Cut Pro) | |
| Add Index (manual or | Storage (tape/digital) | Transfer to distributor |
| automated) | | |

Ability to add/change/edit items (including Voice) and elements
associated with elements (price, color).
Motive behind much of the production procedure is to allow cost
efficiencies that will enable affordable assembly of new commercials
each week.
Circulation and Use
Purchased Time—Over-the-air or cable (Internet and/or Satellite)

| | | |
|---|---|---|
| Immediate Viewing | Delayed and Replay | Internet |
| | Viewing - VCR, | |
| | TiVO, Ultimate TV | |
| Viewing | | |
| Off-the-air | VCR etc., record/ | Personal Computers |
| | playback | (regular and handheld) |

Likely Extension:
Conversion to Website Version, Ethnic (inc. voice only) Demographic editions (males, teens, kids), Separate Geographic regions, Seasonal Themes, Areas of interest (e.g., gardening, do-it-yourself, clothing, entertainment, electronics)

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. Claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

1. A method for advertising comprising:
securing a program slot for display of an advertisement;
recording images;
organizing said recorded images into an advertising specific order presentation;
combining at least one advertising specific order presentation into a composite presentation;
creating an index for the composite presentation; and
coupling the index to the advertising specific order presentation for display to an individual.

2. The method of advertising according to claim 1, said program slot comprising a time length selected from the group consisting of 30, 60, 90, and 120 minutes, or any combination thereof.

3. The method of advertising according to claim 1, wherein said recording of product images occurs through the use of a camera.

4. The method of advertising according to claim 1, wherein the recording of product images occurs through a digital recording device.

5. The method of advertising according to claim 1, wherein recorded product images are stored within a storage device.

6. The method of advertising according to claim 1, wherein recorded product images are edited prior to combination into a composite presentation.

7. The method of advertising according to claim 1, said composite presentation comprising at least two different advertising specific order presentations.

8. The method of advertising according to claim 1, further comprising the step of creating multiple indices for the composite presentation, where one of said indices is directed to an individual demographic classification.

9. The method of advertising according to claim 1, further comprising the step of creating multiple indices for the composite presentation where one of said industries is directed to a language other than English.

10. The method of advertising according to claim 1, wherein said coupling of said index to said advertising specific order presentation occurs manually.

11. The method of advertising according to claim 1, wherein said coupling of said index to said advertising specific order presentation occurs automatically.

12. The method of advertising according to claim 1, wherein said individual scrolls through said composite presentation by reference to said index.

13. The method for advertising apprising:
securing a program slot for display of an advertisement;
recording images;
organizing said recorded images into an advertising specific order presentation;
combining at least one advertising specific order presentation into a composite presentation;
creating an index for the composite presentation;
coupling the index to the advertising specific order presentation; and
transmitting the index and composite presentation for observation and/or recording by an individual.
